(19) United States
(12) Patent Application Publication
(10) Pub. No.: US 2008/0034375 A1
(43) Pub. Date: Feb. 7, 2008

(54) System and method to provide a message service agent with pluggable functionality

(76) Inventor: Terry L. Ferrell, The Colony, TX (US)

Correspondence Address: JACKSON WALKER LLP, 901 MAIN STREET, SUITE 6000, DALLAS, TX, 75202-3797, US

(21) Appl. No.: 11/890,072

(22) Filed: Aug. 3, 2007

Related U.S. Application Data
(60) Provisional application No. 60/835,335, filed on Aug. 3, 2006.

(51) Int. Cl. G06F 3/00

(52) U.S. Cl. 719/314

(57) ABSTRACT

A system and method for providing a message service agent with pluggable functionality acts while a message is being transmitted by the message bus program to examine the content of the message. Once the content of the message has been examined, the message service agent program can: a) further direct the message based on criteria found during the examination of the message content for any additional information relevant to determining other receipt points for the message; b) alter the content of the message (add, remove or change); c) edit the message and change its destination; or d) manipulate the message in some other way. According to the present invention, messages are received by a program message bus and then sent to a “cloud.”

### PRIORITY CLAIM

This application claims priority of U.S. Provisional Patent Application Ser. No. 60/835,335, entitled “SYSTEM AND METHOD TO PROVIDE A MESSAGE SERVICE AGENT WITH PLUGGABLE FUNCTIONALITY” filed Aug. 3, 2006, the teachings of which are incorporated herein by reference.

### FIELD OF THE INVENTION

The present invention relates to the transmission of messages between computers, and more particularly, the present invention relates to the handling of messages while being transmitted by a message bus program.

### BACKGROUND OF THE INVENTION

A message bus is a program with storage that first receives messages and then forwards and delivers the received messages to a designated destination. The designated destination for a message is called a receipt point. Messages in an electronic format typically include a header. The header includes the address(s) of the recipient(s). At the end of the message is another set of information designating the end of the message. In between the address in the header and the information at the end of the message is the message itself. A receipt point is the “address” to which a message is directed by the sending program or message bus.

In a standard or typical message bus program, a message is sent asynchronously to a destination (or perhaps all possible points) or the receipt point (destination). The message bus program accepts the message unconditionally, and does not examine the content of the message, due to processor memory limitations.

### SUMMARY OF INVENTION

The message agent with pluggable functionality of the present invention acts while a message is being transmitted by the message bus program to examine the content of the message. The message agent can allocate processing memory based on predetermined tasks, so as to conserve processing memory. Once the content of the message has been examined, the message service agent program can further direct the message to receipt points other than those in the message header based on predetermined criteria and content found during the examination of the message, can alter the content of the message (such as by adding, removing or modifying content), can edit the message and change its destination, or can manipulate the message in other suitable manners. The processing memory can then be de-allocated, so as to optimize processor memory resources for other functions.

### BRIEF DESCRIPTION OF THE DRAWINGS

FIG. 1 is a diagram of a system depicting a message cloud having a plurality of messages contained therein and multiple pluggable message service agent programs with pluggable instructions, in accordance with an exemplary embodiment of the present invention;

FIG. 2 is a diagram of a message agent in accordance with an exemplary embodiment of the present invention; and

FIG. 3 is a flow chart of a method in accordance with an exemplary embodiment of the present invention.

### DETAILED DESCRIPTION OF THE PRESENT INVENTION

In the description that follows, like parts are marked throughout the specification and drawings with the same reference numerals, respectively. The drawing figures might not be to scale, and certain components can be shown in generalized or schematic form and identified by commercial designations in the interest of clarity and conciseness.

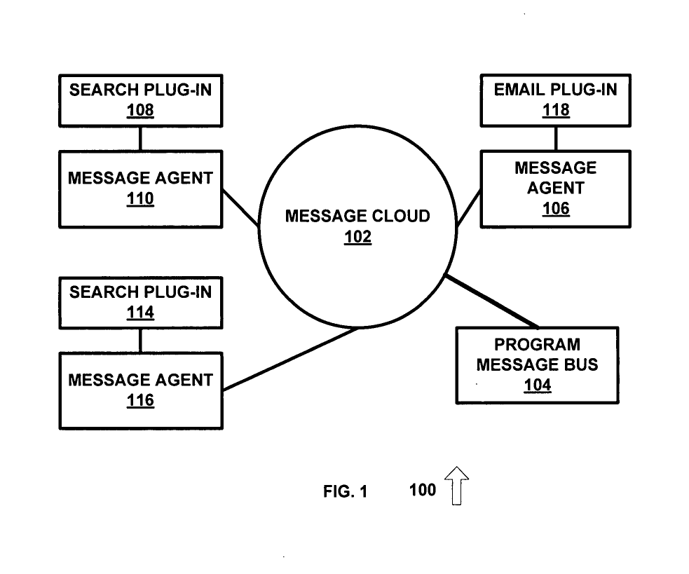

FIG. 1 is a diagram of a system 100 depicting a message cloud 102 having a plurality of messages contained therein and multiple pluggable message service agent programs with pluggable instructions, in accordance with an exemplary embodiment of the present invention. The pluggable message service agent programs and pluggable instructions can control where the message is directed, how the message is to be edited as determined by the discovery of predetermined items of content within the message, or can perform other suitable functions.

System 100 can be implemented in hardware, software, or a suitable combination of hardware and software, and can be one or more software programs operating on one or more suitable processing platforms. As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications or on two or more processors, or other suitable software structures. In one exemplary embodiment, software can include one or more lines of code or other suitable software structures operating in a general purpose software application, such as an operating system, and one or more lines of code or other suitable software structures operating in a specific purpose software application.

In accordance with an exemplary embodiment of the invention, messages are received by program message bus 104 and are then sent to message cloud 102. Message cloud 102 can be electronic data storage, such as the internal memory of a computer, an external memory such as a disk, or other suitable electronic data storage where the messages are indexed in a useful way.

In an exemplary embodiment of the invention, message agents 106, 110 and 116 can be both task non-specific and “pluggable” with a predetermined functionality. Message agents 106, 110 and 116 can deliver messages from message cloud 102 to one or more receipt points, such as from an examination of the contents of the message.

Message agents 106, 110 and 116 can be loaded with a predetermined functionality and run while a message is being transmitted by the program message bus 104, so as to carry out the tasks of examining the message being transmitted for certain criteria and then directing and/or editing the message in a predetermined manner if certain criteria are found within the message. Each of message agents 106, 110 and 116 can serve multiple programming purposes, such as by serving as a container or a receptacle for a set of examination criteria. Different sets of message examination criteria can be substituted or plugged into the message service agent program to meet the current needs for examining message content and creating additional routing instructions for the messages being transmitted by program message bus 104.

In one exemplary embodiment, messages addressed to a certain source, destination, or messages of a certain type may need to be sent to a predetermined location for reasons of priority or to satisfy predetermined conditions before another necessary process can be run. Messages meeting this criteria can be identified by a pluggable set of criteria added to message agents 106, 110 and 116. Message agents 106, 110 and 116 can allocate processing memory and load or plug-in a set of instructions to implement a desired functionality, such as search plug-in 108 or 114 for message agents 110 and 116, respectively, or email plug-in 118 for message agent 106. Once loaded into the associated message agent, the selected functionality can control the operation of the associated message agent when reviewing message traffic by substituting different programming codes within the associated message agent that is examining the content of the message. Message agents 106, 110 and 116 can stop and de-allocate processing memory after completion, so as to increase the amount of processing memory that is available for sets of instruction implementing other functionalities.

Message agents 106, 110 and 116 examine message content and then modify message addressing criteria, edit the message contents or performing some other suitable functions. A set of instructions can be plugged into allocated memory space within the associated message agent when needed and unloaded and the space within the message service agent program de-allocated when not needed. Alternatively, executable code with predetermined functions can be substituted in an instance of a message agent depending on the current needs without having to create another instance.

When a message is found by a message agent that meets the predetermined criteria set for that message agent, the message is extracted from message cloud 102 and sent to the one or more message receipt points by program message bus 104. In one exemplary embodiment, certain messages directed to a certain recipient or discussing a particular subject may also be sent to one or more secure storage locations in an edited or unedited form in addition to the designated recipient.

In one exemplary embodiment of the invention, program message bus 104 is an input/output (I/O) program that uses message agents to find messages in message cloud 102. Once the criteria being sought are identified, the message agent determines the appropriate action for the message based on programming instructions. The message is then forwarded to the destination in the address but may also be left alone or edited and then forwarded to one or more additional receipt points specified in the functionality plugged into the message agent associated with the discovery of a predetermined content within the message.

Different sets of instructions implementing different message search criteria and routing or editing instructions are “pluggable” into the message agent. A message agent can be plugged into or created in allocated memory space—used when needed, then unloaded so that processing memory can be de-allocated when the message agent is no longer needed.

In one exemplary embodiment, message agents can be container programs that are pluggable programs which execute a substitutable set of programming instructions. The programming instructions can vary in purpose and activity to accomplish tasks required for a successful completion of the message bus functions and purposes. For instance, a message agent can be used to handle messages from a certain source message directed to a destination, messages of a certain type, or messages of a certain priority internal to the logic of the program.

When a message is received by the message bus program it is sent to storage (cloud), whether the storage resident memory or disk memory; along with other received messages. The storage is indexed in a useful way so that messages can be located quickly according to both origin and destination.

Messages are located within the cloud and forwarded to their destinations by a message agent that can be modular, that is “pluggable,” and for a specific purpose in the functioning of the message agent.

The message agent can search the “cloud” for messages that meet the criteria set within its programming and perform the task it is programmed to accomplish such as editing or delivery to a message receipt point (destination) or some other destination such as “garbage collection.” When a message is found by the message agent that meets the criteria set with its programming for delivery, the found message is acted upon then extracted from the storage (cloud) and sent to a message receipt point.

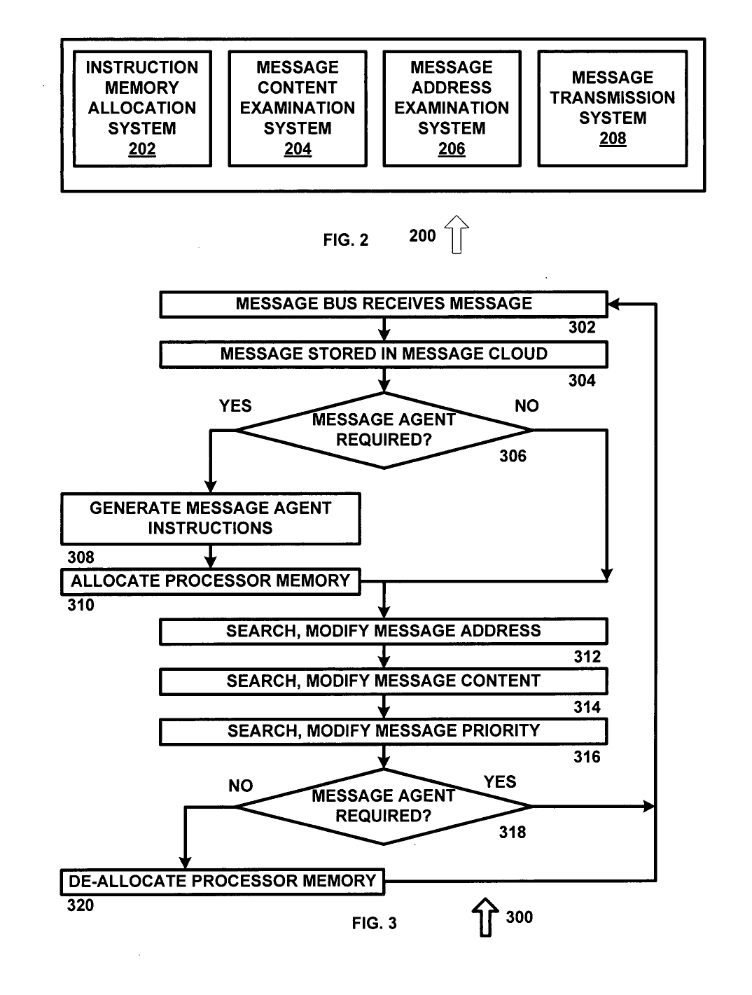

FIG. 2 is a diagram of a message agent 200 in accordance with an exemplary embodiment of the present invention. Message agent 200 includes instruction memory allocation system 202, message content examination system 204, message address examination system 206 and message transmission system 208, each of which can be implemented in hardware, software, or a suitable combination of hardware and software.

Instruction memory allocation system 202 receives instructions, such as from a central processor or other suitable systems, and allocates processor memory for a message agent. In one exemplary embodiment, processor memory can be allocated based on the amount of memory that is required to perform the instructions, such as to search for predetermined data in messages, message addresses, to forward messages to predetermined destinations, or for other suitable functions. In another exemplary embodiment, instruction memory allocation system 202 can de-allocate memory upon completion of a set of instructions by a message agent.

Message content examination system 204 examines content of messages based on instructions received from a central processor or other suitable systems. In one exemplary embodiment, message content examination system 204 can search messages for predetermined data, can search messages selected by message address examination system 206 for predetermined data, can search messages sent within predetermined times for predetermined data (such as messages sent in response to prior commands or messages that are expected within a predetermined time frame), can modify message data content, or can perform other suitable functions.

Message address examination system 206 examines content of message addresses based on instructions received from a central processor or other suitable systems. In one exemplary embodiment, message address examination system 206 can search message addresses for predetermined data, can search messages selected by message content examination system 208 for address data, can search message addresses sent within predetermined times for predetermined data (such as messages sent in response to prior commands or messages that are expected within a predetermined time frame), can modify message address data, can modify address priority data, or can perform other suitable functions.

Message transmission system 208 receives messages after processing and forwards the messages to destinations specified by the message. In one exemplary embodiment, message transmission system 208 can receive messages after they have been processed by message content examination system 204, message address examination system 206 or other suitable systems, can forward messages to a program message bus, can set a memory de-allocation flag for use by instruction memory allocation system 202 or other suitable systems, or can perform other suitable functions.

In operation, message agent 200 performs predetermined functions based on instructions received from a central processor or other suitable systems, so as to allow messages to be examined prior to transmission. Message agent allocates and releases memory based on predetermined tasks, so as to minimize processor memory resources that are required to perform the message agent functions.

FIG. 3 is a flow chart of a method 300 in accordance with an exemplary embodiment of the present invention. Method 300 begins at 302, where a message bus receives a message. In one exemplary embodiment, the message can include address data, content data, priority data, and other suitable data. The method then proceeds to 304, where the message is stored in a message cloud. In one exemplary embodiment, the message cloud can be a data storage device or other suitable devices. The method then proceeds to 306.

At 306, it is determined whether a message agent is required. If it is determined that a message agent is not required, the method proceeds to 312, otherwise the method proceeds to 308 where message agent instructions are generated. In one exemplary embodiment, message agent instruction can include instructions for searching for predetermined message content data, predetermined message address data, predetermined message priority data, or other suitable instructions. The method then proceed to 310, where processor memory is allocated. In one exemplary embodiment, the amount of processor memory can be determined based on the instructions or other suitable data. the method then proceed to 312.

At 312, message address data is searched, modified or other suitable message content functions are performed, if corresponding instructions for the message agent are present. In one exemplary embodiment, the message agent instructions can include one or more data sets that are to be identified within a message address, modifications that are to be made to message address, or other suitable instructions. The method then proceeds to 314.

At 314, message content data is searched, modified or other suitable message content functions are performed, if corresponding instructions for the message agent are present. In one exemplary embodiment, the message agent instructions can include one or more data sets that are to be identified within a message, modifications that are to be made to message data content, or other suitable instructions. Likewise, the instructions can include modifications to content that are to be made based on address data, modifications to address data that are based on content data, or other suitable instruction. The method then proceeds to 316.

At 316, message priority data is searched, modified or other suitable message priority functions are performed, if corresponding instructions for the message agent are present. In one exemplary embodiment, the message agent instructions can include priority instructions if one or more data sets are identified within a message or address, modifications that are to be made to message priority, or other suitable instructions. Likewise, the instructions can include modifications to priority that are to be made based on address or content data, modifications to address or content data that are based on priority data, or other suitable instruction. The method then proceeds to 318.

At 318, it is determined whether the message agent is required. If it is determined that the message agent is required, the method returns to 302. Otherwise, the method proceeds to 320, where the processor memory for the message agent is de-allocated. The method then returns to 302.

In operation, method 300 allows message agents to be created and processor memory to be allocated as required to allow messages to be searched for address data, content data, priority data, or other suitable data, and for address data, content data, priority data, or other suitable data of the message to be added, deleted or otherwise modified based on predetermined instructions for the message agent. Processor memory can be de-allocated when the message agent has completed the instructions.

Though the invention has been described with respect to a specific preferred embodiment, many variations and modifications will become apparent to those skilled in the art upon reading the present application. The tasks to be performed on a message can go beyond re-designating receipt points and content editing. It is therefore the intention that the appended claims be interpreted as broadly as possible in view of the prior art to include all such variations and modifications.

What is claimed is:

1. A method for transmitting messages in an electronic format comprising the steps of:
receiving the electronic messages and sending them to a storage cloud;
searching the storage cloud using a message service agent program for messages meeting a predetermined criteria;
extracting those messages meeting said predetermined criteria from the message cloud;
performing one or more actions on those messages meeting said predetermined criteria, wherein said one or more actions are selected from a group including: adding additional receipt points, and editing the message.

2. The method as defined in claim 1 wherein said predetermined criteria in said message service agent program is selected from a group including: source, destination, type and priority.

3. The method as defined in claim 2 wherein said message service agent program can be created in allocated memory space within said message service agent program when needed and unloaded from said allocated memory space when not needed.
